(19) United States
(12) Patent Application Publication
(10) Pub. No.: US 2011/0029650 A1
(43) Pub. Date: Feb. 3, 2011

(54) METHOD AND SYSTEM FOR HOST INDEPENDENT PLATFORM DIAGNOSTICS

(76) Inventor: Hemal Shah, Trabuco Canyon, CA (US)

Correspondence Address: MCANDREWS HELD & MALLOY, LTD, 500 WEST MADISON STREET, SUITE 3400, CHICAGO, IL, 60661, US

(21) Appl. No.: 12/815,749

(22) Filed: Jun. 15, 2010

Related U.S. Application Data
(60) Provisional application No. 61/230,343, filed on Jul. 31, 2009.
(60) Provisional application No. 61/291,153, filed on Dec. 30, 2009.

(51) Int. Cl. G06F 15/173

(52) U.S. Cl. 709/223

(57) ABSTRACT

A management controller in a network device may provide host-independent diagnostics servicing corresponding to a plurality of managed resources in the network devices. The management controller may be integrated into a network controller in the network device. The diagnostics servicing may be based on one or more management protocols, such as the Web Service Management (WS-Management) protocol. The management controller may log diagnostic data and/or alerts corresponding to the managed resources. The management controller may communicate with the managed resource to request and/or receive the diagnostic data and/or alerts, using Platform Level Data Model (PLDM) based interactions for example. The management controller may incorporate diagnostics based management interface for use during diagnostics management servicing, to exchange diagnostics related management messaging with management devices and/or entities. The diagnostics based management interface may be implemented using Common Information Model (CIM) objects.

### CROSS-REFERENCE TO RELATED APPLICATIONS/INCORPORATION BY REFERENCE

This patent application makes reference to, claims priority to and claims benefit from U.S. Provisional Application Ser. No. 61/230,343, which was filed on Jul. 31, 2009, and U.S. Provisional Application Ser. No. 61/291,153 (Attorney Docket No. 22861 US01), which was filed on Dec. 30, 2009.

Each of above stated applications is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to networking. More specifically, certain embodiments of the invention relate to a method and system for host independent platform diagnostics.

### BACKGROUND OF THE INVENTION

Information Technology (IT) management may require performing remote management operations of remote systems to perform inventory and/or to determine whether remote systems are up-to-date. For example, management devices and/or consoles may perform such operations as discovering and/or navigating management resources in a network, manipulating and/or administrating management resources, requesting and/or controlling subscribing and/or unsubscribing operations, and executing and/or specific management methods and/or procedures. Management devices and/or consoles may communicate with devices in a network to ensure availability of remote systems, to validate that systems may be up-to-date, and/or to perform any security patch updates that may be necessary.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for host independent platform diagnostics, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary communication system comprising a management device and a network device, which may be utilized in accordance with an embodiment of the invention.

FIG. 2A is a block diagram illustrating an exemplary network device that supports host-independent platform diagnostics servicing via a management controller, in accordance with an embodiment of the invention.

FIG. 2B is a block diagram illustrating an exemplary network device that supports host-independent platform diagnostics servicing via a management controller integrated into a network controller, in accordance with an embodiment of the invention.

FIG. 3 is a block diagram illustrating an exemplary management controller that supports host-independent platform diagnostics servicing, in accordance with an embodiment of the invention.

FIG. 4A is a flow chart that illustrates exemplary steps for supporting host independent platform diagnostics, in accordance with an embodiment of the invention.

FIG. 4B is a flow chart that illustrates exemplary steps for discovering and invoking diagnostic tests on resource inside a platform, in accordance with an embodiment of the invention.

FIG. 4C is a flow chart that illustrates exemplary steps for diagnostics indication servicing in a platform, in accordance with an embodiment of the invention.

### DETAILED DESCRIPTION OF THE INVENTION

Certain embodiments of the invention may be found in a method and system for host independent platform diagnostics. In various embodiments of the invention, a management controller in a network device may provide host-independent diagnostic management services. In this regard, the management controller may perform diagnostics management of a plurality of managed resources in the network device, and may perform these services independent of operation of the network device. The management controller may be integrated into a network controller that provides network accessing in the network device. The diagnostic management services performed by the management controller may be based on one or more management protocols, such as Web Service Management (WS-Management) protocols. In this regard, the management controller may incorporate diagnostics based management interface for use during diagnostics servicing, to enable exchanging diagnostics related management messaging with one or more local and/or remote management entities. The diagnostics based management interface may be implemented based on the Common Information Model (CIM). The host-independent diagnostic management services provided by the management controller may be based on diagnostic data and/or alerts generated by and/or corresponding to the plurality of managed resources in the network device. The diagnostic data and/or alerts may be obtained from the plurality of managed resources periodically, dynamically, and/or upon request by the management controller. The management controller may log and/or store the diagnostic data and/or alerts. The management controller may communicate with the plurality of managed resources to request and/or receive the diagnostic data and/or alerts, using Platform Level Data Model (PLDM) based messaging for example.

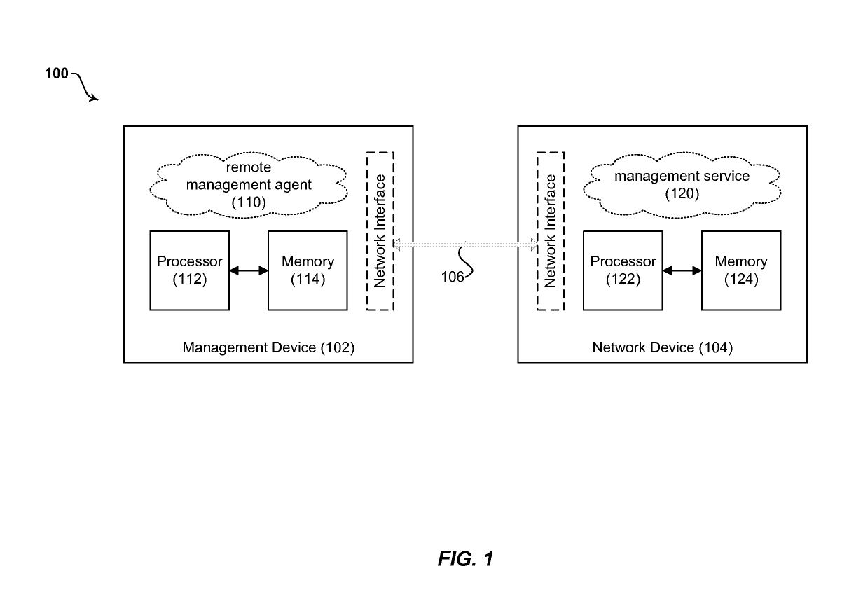

FIG. 1 is a block diagram that illustrates an exemplary communication system comprising a management device and a network device, which may be utilized in accordance with an embodiment of the invention. Referring to FIG. 1, there is shown a network 100 comprising a management device 102 and a network device 104. Also shown in FIG. 1 are a management connection 106, a remote management agent 110, a management service 120, a processor 112, a memory 114, a processor 122, and a memory 124.

The management device 102 may comprise suitable logic, circuitry, interfaces, and/or code that may be operable to manage network devices, such as, for example, the network device 104, in the network 100 using management connections, such as, for example the management connection 106. In this regard, the management device 102 may be utilized by, for example, Information Technology (IT) operators and/or network administrators to manage and/or control various devices in the network 100. Exemplary management operations may comprise discovering and/or navigating resources in a managed network, manipulating and/or administrating managed resources, ensuring availability of remote systems and/or devices, validating that the systems and/or devices (or applications therein) may be up-to-date, requesting and/or controlling subscribing and/or unsubscribing operations, performing security patch updates. Accordingly, the management device 102 may perform management operations, via the remote management agent 110 for example, wherein the management device 102 may utilize a network interface to communicate with devices in the network 100 via the network connection 106.

The processor 112 may comprise suitable logic, circuitry, interfaces, and/or code for control and/or manage operations of the management device 102, and/or performing tasks and/or applications therein, such as management related operations for example. In this regard, the processor 112 may configure and/or control operations of various components and/or subsystems of the management device 102, by generating, for example, control signals. The processor 112 may also control data transfers within the management device 102. The invention may not be limited to a specific processor, but may comprise for example, a general purpose processor, a specialized processor, or any combination of suitable hardware, firmware, software and/or code.

The memory 114 may comprise suitable logic, circuitry, interfaces, and/or code that may enable permanent and/or non-permanent storage and fetching of data and/or code used in the management device 102, during management related processing operations for example. In this regard, the memory 114 may comprise different memory technologies, including, for example, read-only memory (ROM), random access memory (RAM), Flash memory, and/or any combinations thereof.

In an exemplary aspect of the invention, the management device 102 may comprise a dedicated entity, for example the remote management agent 110, to perform management operations based on one or more management standards. In this regard, the remote management agent 110 may comprise suitable logic, circuitry, interfaces, and/or code for performing management operations based on one or more management standards. For example, the remote management agent 110 may enable performing control and/or management operations based on Distributed Management Task Force (DMTF) based Web Service Management (WS-Management) and/or Alert Standard Format (ASF) protocols. The remote management agent 110 may comprise a logical and/or software entity that may be integrated, for example, within an OS running in the management device 102, using the processing 112 and/or the memory 114 for example. The remote management agent 110 may also comprise a logical and/or software entity that may be integrated within a network interface controller (NIC) which may be integrated into the management device 102 for enabling network communications. The remote management agent 110 may also comprise a logical and/or software entity that may be integrated within a dedicated management sub-system within the management device 102.

The network device 104 may comprise suitable logic, circuitry, interfaces, and/or code for supporting management by one or more management devices, such as the management device 102 for example, via one or more management connections, such as the management connection 106 for example. For example, the network device 104 may be integrated into a network, such as the network 100, which may be managed by the management device 102. In this regard, the network device 104 may comprise a personal computer (PC), a server, a mainframe, a network router or switch, a network printer, and/or a dedicated network storage device, which may be operated in a network managed by the management device 102. The network device 104 may also comprise a dedicated entity, for example the management service 120, to enable participating in management operations. Accordingly, the network device 104 may participate in management operations in the network 100 by utilizing a network interface to communicate with management device 102, for example, via the management connection 106.

The processor 122 may comprise suitable logic, circuitry, interfaces, and/or code for control and/or manage operations of the network device 104, and/or performing tasks and/or applications therein, such as management related operations for example. The invention may not be limited to a specific processor, but may comprise for example, a general purpose processor, a specialized processor or any combination of suitable hardware, firmware, software and/or code. The memory 124 may comprise suitable logic, circuitry, interfaces, and/or code that may enable permanent and/or non-permanent storage and fetch of data and/or code used in the network device 104, during management related operations for example. In this regard, the memory 124 may comprise different memory technologies, including, for example, read-only memory (ROM), random access memory (RAM), Flash memory, and/or any combinations thereof.

In an exemplary aspect of the invention, the network device 104 may comprise a dedicated entity, for example the management service 120, to enable participating in management operations, based on one or more management standards. In this regard, the management service 120 may comprise suitable logic, circuitry, interfaces, and/or code for performing and/or participating in management operations and/or communications based on, for example, DMTF based WS-Management and/or ASF protocols. The management service 120 may comprise a logical and/or software entity that may be integrated within an OS running in the network device 104, which may be run via the processor 124. The management service 120 may also comprise a logical and/or software entity that may be integrated within a general network controller (NIC) which may be integrated into the network device 104 for enabling network communications. Alternatively, the management service 120 may comprise a logical and/or software entity that may be integrated within a dedicated management sub-system within the network device 104.

The management connection 106 may comprise an interface and/or a link that may enable interactions between devices in a managed network. In this regard, management connection 106 may comprise a network interface and/or a link that may for providing medium for exchanging management related messaging between management devices, for example the management device 102, and network devices such as the network device 104. The management connection 106 may comprise, for example, an Ethernet (IEEE 802.3) link, which may enable the management device 102 and/or the network device 104 to exchange management related messaging via Ethernet packets transmitted and/or received via one or more wired and/or wireless connections. Accordingly, the management connection 106 may be utilized by the management device 102 and network device 102 to exchange, for example, WS-Management protocol based messaging and/or ASF protocol messaging.

In operation, the management device 102 may manage a plurality of network devices, such as the network device 104, in the network 100. For example, the management device 102 may utilize the management connection 106 to perform management operations in the network device 104. In this regard, the management connection 106 may support exchanging management related messaging based on one or more standards-based management protocols, to enable performing management operations between the management device 102 and the network device 104. For example, the remote management agent 110 and/or the management service 120 may support use of ASF and/or WS-management based messaging, transmitted and/or received via Ethernet packet communicated via the management connection 106, during management operations between the management device 102 and the network device 104. The Alert Standard Format (ASF) protocol may be used in first generation out-of-band management systems. In this regard, the ASF functionality may be implemented using User Datagram Protocol (UDP) based stack, to facilitate communication between management devices and network devices. Accordingly, devices supporting and/or using ASF functionality and/or interfaces may perform and/or participate in management operations using ASF messages, which may be transported via UDP based connections.

The Web Service Management (WS-Management) protocol has been developed as a next generation management protocol. The WS-Management protocol is based on the Simple Object Access Protocol (SOAP), which utilizes XML based messaging and HTTP(S) sessions, and may utilize TCP based transport connectivity for communications between management devices and network devices. Use of SOAP over HTTP(S) may require supporting HTTP/TLS/TCP stack implementation in the management/network devices, which may, however, ensure improved security, reliability, and OS-independent operations. Furthermore, the DMTF has defined a management data model called Common Information Model (CIM), which may be utilized in conjunction with the WS-Management protocol during management operations. The CIM based data model may provide object oriented representation of management data and/or managed resources (and/or management relationships), which may be accessed using WS-Management protocol based messaging. Accordingly, devices supporting and/or using WS-Management and/or CIM based functionality and/or interfaces may perform and/or participate in out-of-band management operations using WS-Management based messaging, which may be transported via TCP connections. For example, in instances where the network device 104 may comprise Intelligent Platform Management Interface (IPMI) and/or ASF based internal communications within the components of the network device 104, the management device 102 may utilize WS-Management based messaging to perform management of the network device 104.

In an exemplary aspect of the invention, the network device 104 may provide host-independent diagnostics related management services. In this regard, the “host” may correspond to hardware, software, firmware, and/or any combinations thereof in network devices which may be used to perform and/or control tasks, applications, and/or services available in the network devices. For example, in the network device 104, the “host” may correspond to the processor 122 and/or the memory 124, an operating system (OS) and/or virtual machines (VMs) running in the network device 104, via the processor 122 and/or the memory 124 for example, and/or applications or processes performed by the OS and/or the VMs. Obtaining diagnostic data and/or alerts may be required during management operations in a network, such as the network 100. For example, diagnostic data and/or alerts may be used by network administrators, via the management device 102 for example, to determine when and/or how issues, errors, and/or problems may occur in managed devices (and resources therein), such as the network device 104. This may also comprise determining conditions and/or events that may have led to any such issues, errors and/or problems. This determination may enable network administrators to address these issues, errors and/or problems; and/or to subsequently account for and/or plan around them by, for example, modifying device configuration to avoid and/or alleviate the conditions and/or events that may have causes them. Obtaining diagnostic data and/or alerts may not be possible sometimes, however, when these issues, errors and/or problems occur. In this regard, affected devices (or managed resources therein) may become unavailable (e.g. go offline) as a result of these issues, errors, and/or problems. For example, the network device 104, or the host environment therein, may lose network connectivity when errors may occur, and thus the management device 102 may be unable to obtain diagnostic data and/or alerts pertaining to these errors. The diagnostic data and/or alerts may also be lost when the managed resources in the network device 104 may stop working, and are subsequently reset and/or rebooted. Furthermore, storage of the diagnostic data and/or alerts, so that they be provided after the affected hosts become available (e.g. returns to an online status) because the storage functionality and/or storage resources used may not be able to preserve the diagnostic data and/or alerts if the whole host is reset.

Accordingly, in various embodiments of the invention, management specific entities, such as the management service 120, and/or any dedicated management components in the network device 104, may be configured to provide diagnostics related management service, which may maintain diagnostic data and/or alerts such that they would be available even when the affected host because unavailable. In this regard, the diagnostic related management service may run independent of the host running in the network device 104, and may be controlled completely remotely, by the remote management agent 110 in the management device 102 for example, using WS-Management based message communications via the connection 106 for example. The diagnostic related management service may obtain diagnostics related data and/or alerts from remaining components of the network device 104. The diagnostics related data and/or alerts may be obtained periodically, upon request, and/or dynamically (e.g. whenever certain condition is met and/or certain event occurs). The diagnostics related management service may remain online, and/or may be available for management interactions, local or remote, when the local host goes offline due to some issues or problems.

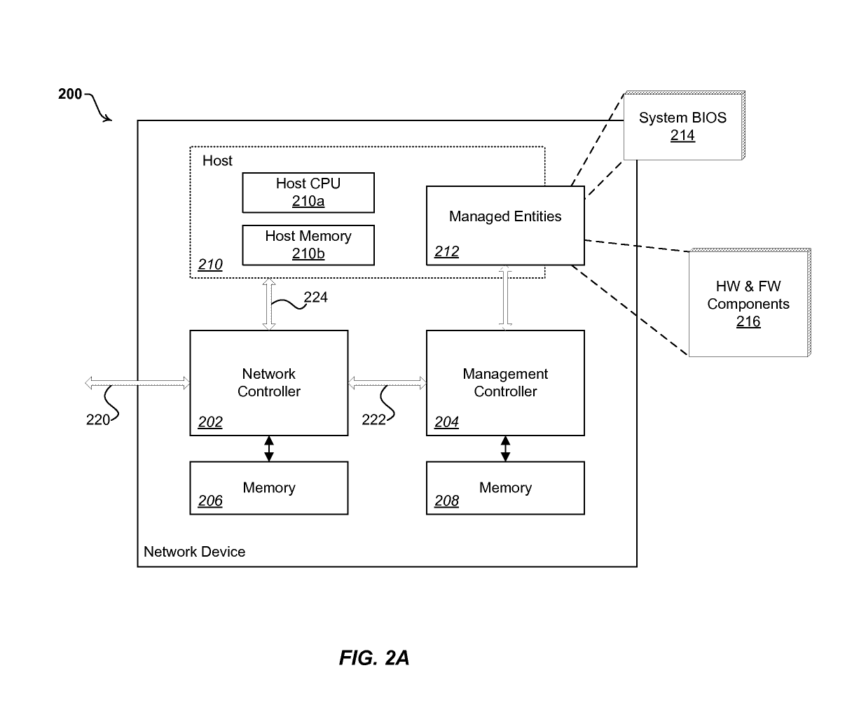

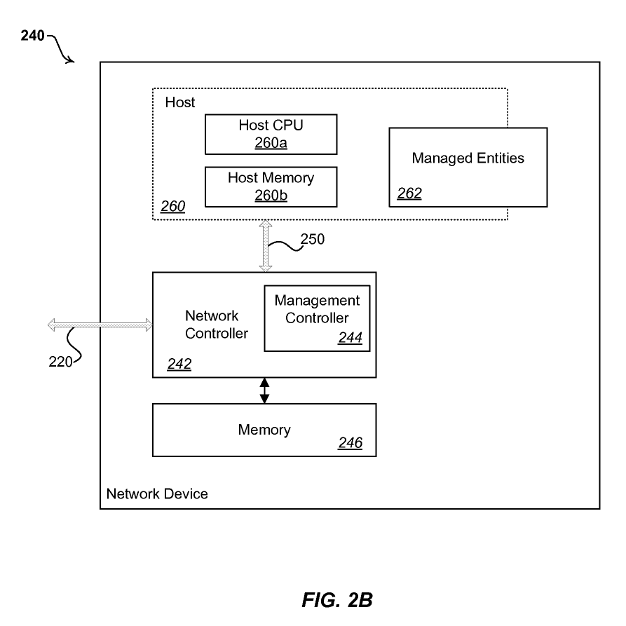

FIG. 2A is a block diagram illustrating an exemplary network device that supports host-independent platform diagnostics servicing via a management controller, in accordance with an embodiment of the invention. Referring to FIG. 2A, there is shown a network device 200, a network controller 202, a management controller 204, a network memory 206, a management memory 208, a host 210, a plurality of managed entities 212, a network traffic 220, a management traffic 222, and a host traffic 224.

The network device 200 may also comprise suitable logic, circuitry, interfaces, and/or code that may enable reception, transmission, and/or processing of network traffic; and/or participating in management operations based on one or more management standards. In this regard, the network device may comprise the network controller 202, the management controller 204, the network memory 206, the management memory 208, and the host 210. The network device 200 may correspond to, for example, the network device 104, substantially as described in FIG. 1.

The network controller 202 may comprise suitable logic, circuitry, interfaces, and/or code that may handle network traffic, such as the network traffic 220, which may be received and/or transmitted by the network device 200. In this regard, the network controller 202 may comprise a network interface controller (NIC). The network memory 206 may comprise suitable logic, circuitry, interfaces, and/or code that may enable buffering, storage and/or retrieval of data and/or code used and/or processed by the network controller 202. In this regard, the network memory 206 may comprise a dedicated memory component and/or a dedicated partition in a common memory component used in the network device 200. Exemplary memory technologies may comprise, for example, non-volatile random access memory (NVRAM) and/or Flash memory.

The management controller 204 may comprise suitable logic, circuitry, interfaces, and/or code that may be operable to perform and/or provide management operations and/or services in the network device 200, which may be based on one or more management protocols such as the WS-Management for example, and/or to support corresponding interactions and/or messaging with management entities. In this regard, the management controller 204 may be operable to process the management traffic 222, received and/or transmitted via the network controller 202 for example, as part of the network traffic 220. To facilitate and/or support management operations and/or services, the management controller 204 may be operable to interact with other components and/or subsystems in the network device 200, such as the managed entities 212, to provide configuration and/or control data, and/or to obtain feedback and/or status information as needed to perform supported management operations and/or services. For example, the management controller 204 may support, for example, WS-Management/CIM based management services. In this regard, the management controller 204 may generate and/or process messaging and/or data, which may be communicated using the WS-Management/CIM. Additionally, the management controller 204 may interact with the managed entities 212, for example, to query, log, and/or store messaging and/or data pertaining to events occurring, in the managed entities 212, which may trigger communication of WS-Management/CIM based indications.

The management memory 208 may comprise suitable logic, circuitry, interfaces, and/or code that may enable storage and/or retrieval of data and/or code, which may be utilized by the management controller 204, for example. In this regard, the management memory 208 may comprise different memory technologies, including, for example, non-volatile random access memory (NVRAM) and/or Flash memory. CIM based indication related operations. In an exemplary aspect of the invention, the management controller may be operable to provide host-independent diagnostic management servicing in the network device 200.

The host 210 may correspond to components and/or subsystems in the network device 200 used for running and/or executing processes, tasks, and/or applications which may be provided, to device user for example, via the network device 200. In this regard, the host 210 may correspond to one or more CPUs 210a, one or more memories 210b, dedicated processing and/or storage resources, input/output subsystems, an operating system (OS), one or more virtual machines (VMs), and/or any applications running therein. In an exemplary aspect of the invention at least a subset of the components and/or subsystems in the host 210, represented by the managed entities 212, may be managed using one or more management protocols.

The managed entities 212 may comprise suitable logic, circuitry, interfaces, and/or code that may be controlled, managed, and/or utilized during management operations in the network device 200. For example, the managed entities 212 may comprise an operating system (OS) or a plurality of virtual machines (VMs), and/or applications running therein, a chipset, one or more sensors, and/or one or more intelligent devices that may reside within the network device 200. Furthermore, some of the managed entities 212 may operate, and/or may be managed independent of the host 210. The managed entities may comprise, for example, a Basic Input/Output System (BIOS) 214 and a plurality of hardware and/or firmware components 216.

The BIOS 214 may comprise suitable logic, circuitry, interfaces and/or code for initializing, configuring, and/or controlling components, such as input/output (I/O) components, in the network device 200, during power up sequences for example. The BIOS 214 may comprise code stored in a read-only memory (ROM), for example, which may be executed upon power up of the network device 200, to identify, test, and initialize (“boot up”) various components of the network device 200. Therefore, prior to completion of the boot up, the network device 200 may have limited functionality. For example, during boot up, the BIOS 214 may initialize and/or start up an operating system (OS) and/or a virtual machine monitor (VMM) or hypervisor, on the network device 200. Consequently, a host environment, corresponding to the host 210, which may typically run on the network device during normal functionality, may not be running prior to completion of boot up.

The plurality of hardware and/or firmware components 216 may comprise, for example, one or more of: one or more hard disk drives, one or more NVRAM elements, one or more Ethernet controllers, and one or more wireless (e.g., WLAN) controllers. The managed entities 212 may be operable to access and/or be accessed by the host 210 and/or the management controller 204. In an exemplary aspect of the invention, at least some of managed entities, such as the hardware and/or firmware components 216, may run independent from the host 201. Accordingly, management operations pertaining to the hardware and/or firmware components 216 may be performed independently. In this regard, a diagnostics execution environment may run, for example, on the hardware and/or firmware components 216 such that diagnostics may be performed without regard to a state or condition of the host 210.

The network traffic 220 may comprise network packets received and/or transmitted by the network device 200 via a network connection, which may comprise, for example, an Ethernet (IEEE 802.3) connection. In this regard, data carried via the network traffic 220 may correspond to the host traffic 224 and/or management traffic 222. The host traffic 224 may comprise data and/or messages transmitted and/or received by the host 210 (and/or applications or processes running therein). For example, the host traffic 224 may comprise data transmitted and/or received by web browsing applications that may be running in the network device 104. The management traffic 222 may comprise data and/or messages transmitted and/or received by the network device 200 during management operations, which may be handed by the management controller 204. For example, the management traffic 222 may comprise WS-Management based messages communicated to and/or from the network device 200, to support WS-Management services and/or applications performed therein.

In operation, the network controller 202 may receive, transmit, and/or process the network traffic 220, and may utilize the network memory 206 to retrieve and/or store data and/or code that may be utilized during processing of network traffic 220. The management controller 204 may be operable to perform management operations in the network device 200, and/or to receive, transmit, and/or process the management traffic 222. The management controller 204 may utilize the management memory 208 to retrieve and/or store data and/or code that may be utilized during processing of management traffic 222. In this regard, the management controller 204 may perform, control, and/or support management services and/or operations provided by and/or performed in the network device 200, and/or may perform necessary interactions with management entities, such as the management device 102, for example, during these management operations and/or services. The management controller may support in-band and/or out-of-band management of the managed entities 212. In this regard, the management controller 204 may interact with managed entities 212, to configure and/or modify the managed entities 212, based on messages received from management devices and/or entities for example. The management controller may also interact with the managed entities 212 to query, log, and/or store data pertaining to events and/or errors occurring therein, and/or to determine conditions thereof. The interactions between the management controller 204 and the managed entities 212 may be performed indirectly, via the network controller 202 for example. Alternatively, the management controller 204 and may interact directly with the managed entities 212, via a dedicated management bus (not shown) for example, which may comprise a System Management Bus (SMBus) and/or a management Peripheral Component Interconnect Express (PCI-e) bus.

In various embodiments of the invention, the network device 200 may provide host-independent diagnostics related management services, via the management controller 204 for example. In this regard, the management controller 204 may be used to query, receive, and/or log diagnostic data and/or alerts corresponding to components and/or subsystems in the network device 200, such as the managed entities 212 for example. Diagnostic data and/or alerts may be used by network administrators to determine when and/or how issues, errors, and/or problems occur in managed devices (and resources therein), such the network device 200, and/or to modify and/or adjust configuration and/or management operations thereafter, substantially as described with regard to FIG. 1 for example. Providing the diagnostics servicing via the management controller 204 may be beneficial because obtaining diagnostic data and/or alerts may not be possible when issues and/or errors occur since the affected component(s) and/or resource(s) may become unavailable (e.g. go offline) as a result of the issues and/or errors. For example, when issues and/or occur in one or more of the managed entities 212, corresponding diagnostic data and/or alerts may become unavailable and/or may be lost because the host 210 may go offline and/or when the host 210 is reset.

Accordingly, diagnostics related management services may be integrated into the management controller 204 to ensure that diagnostic data and/or alerts may remain available even when the host 210 may become unavailable. In this regard, the diagnostic related management services provided by the management controller 204 may run independent of the host 210, and/or any applications and/or functionality available therein. For example, the diagnostics related management services may comprise providing diagnostics related interactions directly by the management controller 204. This may ensure that the diagnostic data and/or alerts would remain accessible, by remote management entities and/or local management consoles (i.e. local management GUI) for example. These management entities may communicate directly with the management controller 204, independent of the host 210, via the network controller 202, using WS-Management based messages for example. In this regard, the WS-Management messages may be communicated via network packets transmitted and/or received by the network controller 202 for example. The diagnostic related management service available directly via the management controller 204 may also comprise querying, receiving, and/or logging diagnostics related data and/or alerts generated by and/or based on operations of, for example, the managed entities 212 in the host 210. In this regard, the diagnostic data and/or alerts may be obtained, by the diagnostics related management service in the management controller 204, periodically, by request, and/or dynamically. For example, the management controller 204 may interact with the managed entities 212, using a management related interface for example, to request diagnostic data and/or alerts. The management controller 204 may also interact with the managed entities 212 to specify, for example, timing for providing diagnostic data and/or alerts at certain intervals. The diagnostic data and/or alerts may also be generated and/or communicated by the managed entities 212 when one or more certain conditions are met and/or one or more certain events occur in the effected resources. In this regard, the management controller 204 may interact with the managed entities 212 to specify those certain conditions and/or events, based on input and/or information which may be received from, for example, network administrators and/or device users.

FIG. 2B is a block diagram illustrating an exemplary network device that supports host-independent platform diagnostics servicing via a management controller integrated into a network controller, in accordance with an embodiment of the invention. Referring to FIG. 2B, there is shown a network device 240, a network controller 242, a management controller 244, a memory 246, and a host 260 comprising a plurality of managed entities 262.

The network device 240 may be similar to the network device 200, substantially as described with regard to, for example, FIG. 2A. The management controller 244, however, may be integrated into the network controller 242 rather than being a separate dedicated entity. The network device 240 may comprise, for example, the network controller 242, the memory 246, the host 260, and the managed entities 262. The network controller 242 may comprise the management controller 244.

The network controller 242 may be similar to the network controller 202, substantially as described with regard to FIG. 2A. In this regard, the network controller 242 may comprise suitable logic, circuitry, interfaces, and/or code for handling and/or processing network traffic, which may be received and/or transmitted by the network device 240. For example, the network controller 242 may comprise a network interface controller (NIC). The network controller 242 may interact with the host 260, via a host-NIC interface 250. The host-NIC interface 250 may comprise suitable logic, circuitry, interfaces, and/or code for exchanging data and/or messages between the network controller 242 and the host 260 (and/or any components therein). In this regard, the host-NIC interface 250 may comprise a PCI-e bus. In an exemplary embodiment of the invention, the management controller 244 may be integrated into the network controller 242.

The management controller 244 may be similar to the management controller 204, substantially as described with regard to FIG. 2A. In this regard, the management controller 244 may comprise suitable logic, circuitry, interfaces, and/or code that may be operable to perform and/or provide management operations and/or services in the network device 240, which may be based on one or more management protocols such as the WS-Management for example. The network controller 404 may also enable interactions and/or messaging with management entities, such as remote management consoles running in management devices and/or local management consoles, which may be run directly via the network device 240 using, for example, a dedicated management user interface. The management controller 244 may be operable to process management messaging and/or data, received and/or transmitted via the network controller 242, for example, as part of the network traffic 220. The management controller 244 may also interact, during management operations and/or services, with other components and/or subsystems in the network device 240, such as the managed entities 242, substantially as described with regard to the management controller 204 of FIG. 2A.

The memory 246 may comprise suitable logic, circuitry, interfaces, and/or code that may enable buffering, storage and/or retrieval of data and/or code used and/or processed by the network controller 242. In this regard, the network memory 246 may comprise a dedicated memory component and/or a dedicated partition in a common memory component used in the network device 240. Exemplary memory technologies may comprise, for example, non-volatile random access memory (NVRAM) and/or Flash memory. The memory 246 may also be utilized by the management controller 244 integrated into the network controller 242, for buffering, storing, and/or retrieving data and/or code used during management operations and/or services for example.

The host 260 may be similar to the host 210, substantially as described with regard to FIG. 2A. In this regard, the host 260 may correspond to a plurality of components and/or subsystems in the network device 240 which may be used for running and/or executing processes, tasks, and/or applications performed by the network device 240 during normal functionality thereof. In this regard, the host 260 may comprise one or more CPUs 260a, one or more memories 260b, and/or additional dedicated processing and/or storage resources, input/output subsystems, an operating system (OS), one or more virtual machines (VMs), and/or any applications running therein. In an exemplary aspect of the invention, at least a subset of the components and/or subsystems comprising the host 260, represented by the managed entities 262, may be managed using one or more management protocols, such as WS-Management

The managed entities 262 may comprise components and/or subsystems of the network device 240 which may be controlled, managed, and/or utilized during management operations in the network device 240. In this regard, the managed entities 262 may comprise processing and/or storage resources, a plurality of hardware and/or firmware components, a Basic Input/Output System (BIOS), an operating system (OS), one or more virtual machines (VMs), and/or one or more sensors which may reside within the network device 240.

In operation, the network device 240 may be operable to process and/or handle network traffic 220, and/or to perform management operations and/or services substantially as described with regard to network device 200 in FIG. 2A. In this regard, the network controller 242 may receive, transmit, and/or process the network traffic 220, and may utilize the memory 246 to retrieve and/or store data and/or code that may be utilized during processing of network traffic 220. The management controller 244 may be operable to perform management operations and/or services in the network device 240, and/or to receive, transmit, and/or process management messages and/or data transmitted and/or received via network packets as part of the network traffic 220. For example, the management controller 244 may be operable to manage the operation of the managed entities 262. In this regard, the management controller may support in-band and/or out-of-band management of the managed entities 262.

The management controller 244 may interact with managed entities 262, using the host-N IC interface 250 for example, to configure and/or modify the managed entities 262, based on, for example, management messaging received from remote or local management entities. The management controller 244 may also interact with the managed entities 262 to query, log, and/or store data pertaining to events and/or errors occurring therein, and/or to determine conditions thereof. In an exemplary aspect of the invention, the management controller 244 may support WS-Management/CIM based management services. In this regard, the management controller 244 may generate and/or process messaging and/or data, which may be communicated using the WS-Management/CIM. The management controller 244 may interact with the managed entities 262, via the host-NIC interface 250 for example, to query, log, and/or store messages and/or data pertaining to events occurring, in the managed entities 262, which may trigger communication of WS-Management/CIM based indications.

In various embodiments of the invention, the network device 240 may provide host-independent diagnostics related management services, via the management controller 244 for example, substantially as described with regard to, for example, FIG. 2A. The management controller 244 may be used, for example, to request, receive, and/or log diagnostic data and/or alerts corresponding to components and/or subsystems in the network device 240, such as the managed entities 262 for example. Providing diagnostics related management services via the management controller 244 may ensure that the diagnostic data and/or alerts may be available even when the host 260 (or any component thereof) may become unavailable. In this regard, the diagnostic related management services provided by the management controller 244 may run independent of the host 260, and/or any applications and/or functionality available therein. For example, the diagnostics related management services may comprise supporting, by the management controller 244 diagnostics based interactions with management entities, such as remote management consoles running in management devices and/or local management consoles running in the network device 240. This may ensure that the diagnostic data and/or alerts may remain available, and may be communicated directly by the management controller 244 via the network controller 242, independent of the host 260; using WS-Management based messages for example. In this regard, the WS-Management messages may be communicated via network packets transmitted and/or received by the network controller 242 for example. The diagnostic related management services available via the management controller 244 may comprise querying, receiving, and/or logging diagnostics related data and/or alerts generated by and/or based on operations of, for example, the managed entities 262 in the host 260. In this regard, the diagnostic data and/or alerts may be obtained, by the diagnostics related management service in the management controller 244, via the host-NIC interface 250 for example, periodically, by request, and/or dynamically, substantially as described with regard to FIG. 2A for example.

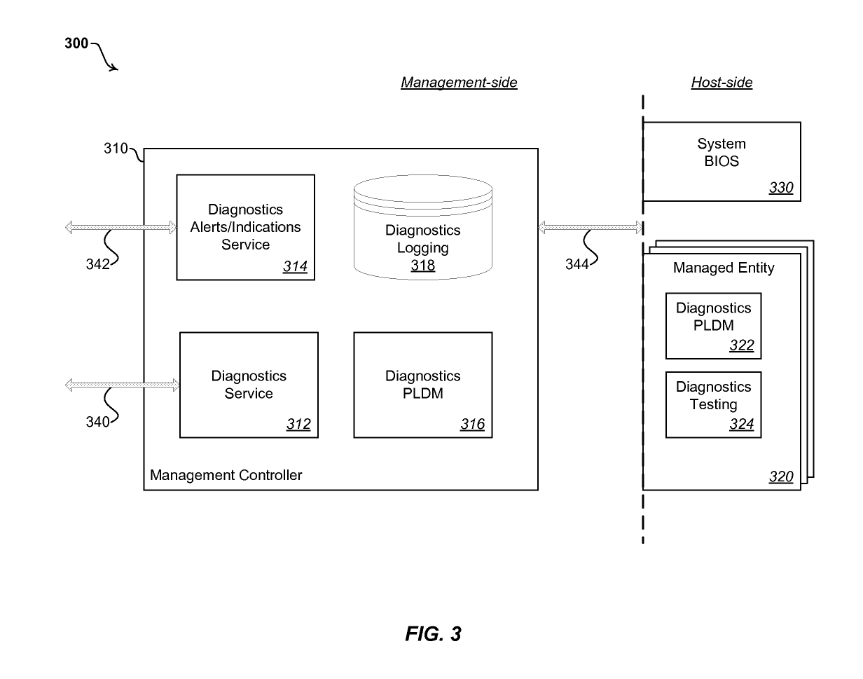

FIG. 3 is a block diagram illustrating an exemplary management controller that supports host-independent platform diagnostics servicing, in accordance with an embodiment of the invention. Referring to FIG. 3 there is shown a platform 300, a management controller 310, a diagnostics service module 312, diagnostic alerts and indications service module 314, a management-side Platform Level Data Model (PLDM) interfacing and processing module 316, and a diagnostics logging module 318. Also shown in FIG. 3, on the host-side, are a system BIOS 330 and a plurality of managed entities 320. Each managed entity 320 may comprise a resource-side PLDM interfacing and processing module 322 and a diagnostics testing module 324.

The platform 300 may comprise, for example, a server, a computer, a network device such as a router or switch, and/or a mainframe. The platform 300 may correspond to the network device 200 or 240 of FIGS. 2A and 2B. The platform 300 may comprise the management controller 310, the plurality of managed entities 320, and the system BIOS 330.

The management controller 310 may comprise suitable logic, circuitry, interfaces and/or code that may be operable to provide management operations and/or services in accordance with the invention described herein. In this regard, the management controller 310 may be integrated into a platform, such the platform 300, to provide management operations and/or services based on the WS-Management protocol(s) for example. The management controller 310 may correspond to, for example, the management controller 204 of FIG. 2A or the management controller 304 of FIG. 2B. Accordingly, the management controller 310 may be operable to provide host-independent diagnostics services, substantially as described with regard to, for example, FIGS. 2A and 2B. In an exemplary embodiment of the invention described herein, the management controller 310 may comprise the Diagnostics service module 312, the diagnostic alerts and indications service module 314, the management-side PLDM interfacing and processing module 316, and the diagnostics logging module 318.

The diagnostics service module 312 may comprise suitable logic, circuitry, interfaces and/or code for providing independent diagnostics servicing in the platform 300. For example, the diagnostics service module 312 may provide host-independent diagnostic related management operations pertaining to components of the platform 300. In this regard, the diagnostic related management operations may be available even in instances where host processor(s) and/or any existing OS and/or VMs which may be used in normal operations of the platform 300 may not be running. The diagnostic service module 312 may be also operable be used to diagnose and repair the affected components and/or subsystems. In various embodiments of the invention, the diagnostics service module 312 may expose the platform 300, or any components thereof, using, for example, Common Information Model (CIM) based data models and/or objects. Using such data models, the diagnostics service module 312 may expose, for example, its diagnostics capabilities, available diagnostic tests, and execution capabilities. Accordingly, local/remote based diagnostics management may be performed via CIM-based communication 340, which may be used to exchange diagnostics related management messages and/or data with management entities, such as the remote management agent 110 in the management device 102 of FIG. 1, and/or a local management console (not shown) which may be run directly on the platform 300. In this regard the CIM-based communication 340 may be carried via network packets transmitted and/or supported via a network controller, such as the network controllers 202 or 242 of FIGS. 2A and 2B.

The diagnostic alerts and indications service module 314 may comprise suitable logic, circuitry, interfaces and/or code for communicating messages and/or data regarding platform diagnostics events, which may be provided in the form of diagnostics alerts and/or indications, to local and/or remote management entities, via the alert-based communication 342 for example. The diagnostic alerts and indications service module 314 may expose, for example, a subscription based model to one or more local or remote clients for the diagnostics indications. Accordingly, the diagnostic alerts and indications service module 314 may be used to send alert-based indications to management entities, such as the remote management agent 110 of the management device 102 of FIG. 1, in instances where diagnostics alerts are detected in the platform 300. In this regard the alert-based communication 342 may be carried via network packets transmitted via, for example, the network controller 202 or 242 of FIGS. 2A and 2B.

The management-side PLDM interfacing and processing module 316 may comprise suitable logic, circuitry, interfaces and/or code for supporting PLDM based interactions between the management controller 310, or one or more components thereof, and managed entities, by enabling communicating of PLDM based messages to and/or from managed components, such as the plurality of managed entities 320. The Platform Level Data Model (PLDM) based messaging may be used to enable platform-independent communication between dedicated management components in a platform, such as the platform 300, and managed subsystems and/or components in the platform, such as the managed entity 320. The PLDM based messaging may enable management messaging that may be utilized uniformly in a managed network regardless of the variations and/or specification of each of the platforms in the network. PLDM based messaging may provide efficient access to low-level platform monitoring, control, and data transfer functions such as, for example, temperature, fan, voltage, inventory data, event data transfer, and boot control. The management controller 310 may use this low level data model to perform request-response style communication with the resources and/or components in the platform 300 that may be managed via the management controller 310.

The diagnostics logging module 318 may comprise suitable logic, circuitry, interfaces and/or code for logging and/or storing diagnostic data and/or alerts generated in the platform 300. In this regard, the diagnostics logging module 318 may store, for example, diagnostics alerts generated via one or more of the managed entities 320 and/or the system BIOS 330. The diagnostics logging module 318 may be accessible by, and/or interacts with local or remote management entities using, for example, external interfacing CIM data models and/or objects, via the diagnostics service module 312 and/or the diagnostic alerts and indications service module 314. The diagnostics log 120 may be accessible within the platform 300 using PLDM based communications, via the management-side PLDM interfacing and processing module 316.

Each of the plurality of managed entities 320 may correspond to a resource in the platform 300, which may be managed via the management controller 310. In this regard, the plurality of managed entities 320 may correspond to the managed entities 212 of FIG. 2A or the managed entities 262 of FIG. 2B. In an exemplary embodiment of the invention described herein, the managed entity 320 may be operable to perform and/or support various diagnostic and/or management functions, and to generate corresponding diagnostic information and/or parameters. The diagnostic functions may comprise, for example, monitoring environmental conditions, monitoring voltage and/or current levels, and monitoring for hardware failures. The management functions may comprise, for example, rebooting the platform, adjusting clock speeds, adjusting fans speeds, and powering components on and/or off. In this regard, each managed entity 320 may comprise an instance of the resource-side PLDM interfacing and processing module 322 and instance of the diagnostics testing module 324.

The resource-side PLDM interfacing and processing module 322 may comprise suitable logic, circuitry, interfaces and/or code for supporting PLDM based interactions between the managed entity 320 and the management controller 310, by enabling communicating of PLDM based messages.

The diagnostics testing module 324 may comprise suitable logic, circuitry, interfaces and/or code for performing diagnostics testing functionality in the managed entity 320, based on input, command, and/or data provided by the management controller 310 for example.

The system BIOS 330 may comprise suitable logic, circuitry, interfaces and/or code for initializing, configuring, and/or controlling components, such as input/output (I/O) components, in a platform, such as the platform 300, in certain situations, such as during power up sequences. The system BIOS 330 may comprise code stored in a read-only memory (ROM), for example, which may be executed upon power up of the platform 300, to identify, test, and initialize (“boot up”) various hardware components the platform 300. Therefore, prior to completion of the boot up, the platform 300 may have limited functionality. For example, during boot up, the system BIOS 330 may initialize and/or start up an operating system (OS) and/or a virtual machine (VM), on the platform 300. Consequently, a host environment that typically runs on the platform 300 may not be running prior to completion of boot up.

In operation, the management controller 310 may be operable to provide host-independent diagnostic management environment in the platform 300. In this regard, the system BIOS 300 and/or the plurality of managed entities 320 may communicate with the management controller 310, via a host-management interface 344, to communicate diagnostics related data and/or alerts generated in the system BIOS 300 and/or the plurality of managed entities 320, and/or to receive diagnostics related management input and/or commands from the management controller 300. For example, any diagnostics alerts that may be generated in system BIOS during boot up operations, and/or in one or more managed entities 320 during normal operations thereafter may be communicated to the management controller 310. The diagnostics alerts may be logged, via the diagnostics logging module 318 for example, and/or alert based indications may be communicated thereafter to management entities, via the diagnostic alerts and indications service module 314.

The management-side PLDM interfacing and processing module 316 and the resource-side PLDM interfacing and processing module 322 may enable PLDM-based diagnostics messaging, via the host-management interface 344, between the management controller 310 and each managed entity 320. In this regard, the management controller 310 may generate and/or send PLDM-based commands via the management-side PLDM interfacing and processing module 316. The PLDM-based diagnostics commands may be utilized to request diagnostic data and/or alerts, and/or to configure the managed entity 320 to communicate diagnostic data and/or alerts periodically and/or dynamically. The PLDM-based diagnostics commands may also be used to trigger diagnostic tests that may be executed and/or run, in the managed entity 320, via the diagnostics testing module 324. The managed entity 320 may communicate diagnostic data to management controller 310 using, for example, PLDM-based response or indication messages, which may be generated and/or sent via the resource-side PLDM interfacing and processing module 322.

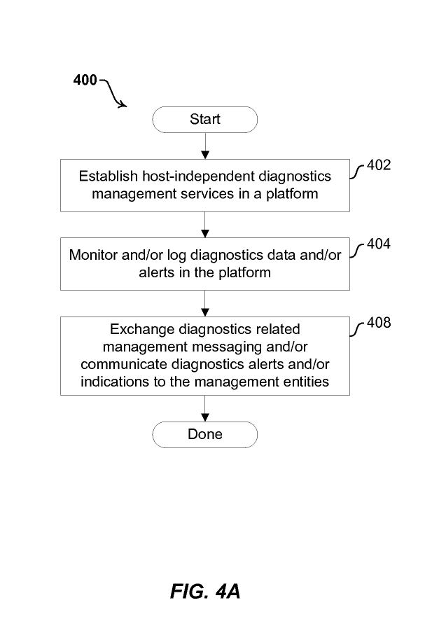

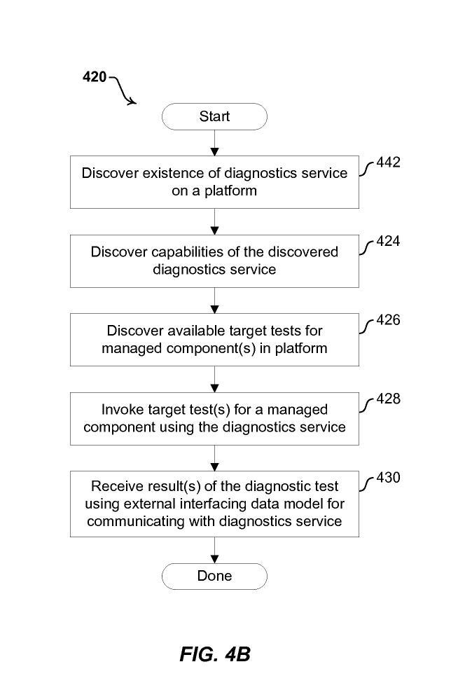

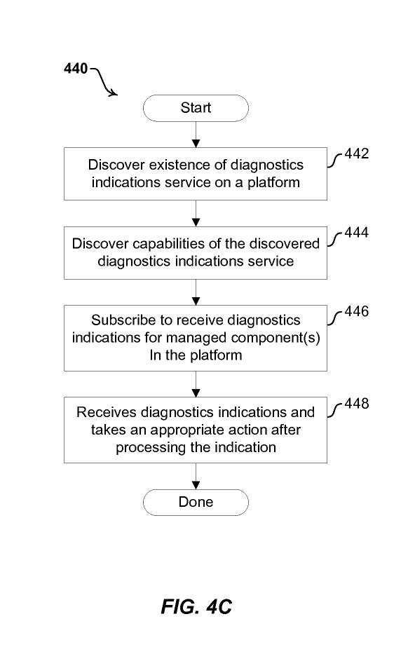

FIG. 4A is a flow chart that illustrates exemplary steps for supporting host independent platform diagnostics, in accordance with an embodiment of the invention. Referring to FIG. 4A, there is shown a flow chart 400 comprising a plurality of exemplary steps that may be performed to enable host independent platform diagnostics.

In step 402, a host-independent diagnostic management environment and/or services may be established in a platform. For example, the management controller 310 may be utilized to provide host-independent diagnostics services in the platform 300. In this regard, the management controller 310 may provide host-independent interactivity with management entities, which may be used to communicate diagnostics related management messaging. Furthermore, the management controller may enable logging and/or storing of diagnostic data and/or alerts to prevent their loss, in instances where the host becomes unavailable for example. In step 404, diagnostic data and/or alerts may be monitored and/or logged by a management controller in the network device. For example, diagnostic data and/or alerts may be logged in the diagnostics logging module 318 of the management controller 310 of the platform 300. In step 406, diagnostics related management messaging may be exchanged and/or diagnostics related alert indications may be transmitted to management entities.

FIG. 4B is a flow chart that illustrates exemplary steps for discovering and invoking diagnostic tests on resource inside a platform, in accordance with an embodiment of the invention. Referring to FIG. 4B, there is shown a flow chart 420 comprising a plurality of exemplary steps that may be performed by a management entity to discover and invoke diagnostic testing in a platform.

In step 422, a management entity, which may be local or remote, may discover the existence of diagnostics service on a platform. For example, the remote management agent 110 running in the management device 102 may discover the existence and/or availability of the diagnostic service module 312 in the platform 300. In step 424, the management entity may discover capabilities of the discovered diagnostics service. For example, the remote management agent 110 may utilize the CIM-based communication 340 to interact with the diagnostic service module 312 to discover its capabilities and/or services available therein. In step 426, the management entity may discover available target tests for managed component(s) in the platform. For example, based on its interactions with the diagnostic service module 312, the remote management agent 110 may determine available diagnostic tests for one or more of the managed entities 320 in the platform 300.

In step 428, the management entity may invoke target diagnostic tests for managed components in the platforms. For example, the remote management agent 110 may communicate with the management controller 310 to invoke target test(s) for a managed entity 320. In this regard, the diagnostics service module 312 may trigger, via the host-management interface 344, one or more diagnostic tests in the managed entity 320, which may be performed therein via the diagnostics testing module 324. In this regard, the diagnostics service module 312 may utilize PLDM messages, which may be communicate via the via the host-management interface 344 using the management-side PLDM interfacing and processing module 316 and the resource-side PLDM interfacing and processing module 322, to invoke and/or trigger target test(s) on the managed entity 320. The diagnostic tests may be performed in the managed entity 320, via the diagnostics testing module 324 for example, and the result(s) may be communicated back to the management controller 310, also using PLDM messages for example. The results may be logged in the management controller 310 using, for example, the diagnostics logging module 318. In step 430, the management entity may receive result(s) of the diagnostic testing performed in the managed components. The results may be communicated by the management controller 310, via the CIM-based communication 340 for example, on request, periodically, and/or dynamically.

FIG. 4C is a flow chart that illustrates exemplary steps for diagnostics indication servicing in a platform, in accordance with an embodiment of the invention. Referring to FIG. 4C, there is shown a flow chart 440 comprising a plurality of exemplary steps that may be performed by a management entity to invoke diagnostics indication servicing in a platform.

In step 442, a management entity, which may be local or remote, may discover existence of diagnostics alerts/indications service on a platform. For example, the remote management agent 110 running in the management device 102 may discover existence and/or availability of the diagnostic alerts and/or indications service module 314 in the platform 300. In step 424, the management entity may discover capabilities of the discovered diagnostics service. For example, the remote management agent 110 may interact with the diagnostic alerts and/or indications service module 314 to discover its capabilities and/or services available therein. In step 446, the management entity may subscribe to receive diagnostics alerts and/or indications for managed component(s) in the platform. For example, the remote management agent 110 may configure itself and/or the diagnostic alerts and/or indications service module 314, using CIM-based objects and/or WS-Management messages for example, enable receiving diagnostic alerts and/or indications from the diagnostic alerts and/or indications service module 314, via the alert-based communication 342, for example.

Events occurring thereafter in managed component(s) in the platform 300, such as the system BIOS 330 and/or one or more managed entities 320, may trigger diagnostics alerts and/or indications. The diagnostic alert and/or indication information may then be communicated to the management controller 310, via PLDM messages, which may be communicated via the host-management interface 344 using the management-side PLDM interfacing and processing module 316 and the resource-side PLDM interfacing and processing module 322. The management controller 310 may then log the diagnostics alerts and/or indications via the diagnostics logging module 318. Corresponding diagnostics alerts and/or indications may then be communicated to the management entity.

In step 448, the remote management agent 110 may receive diagnostics alerts and/or indications corresponding to the system BIOS 330 and/or one or more managed entities 320 in the platform 300. The remote management agent 110 may take appropriate actions after processing the received alerts and/or indications. This may comprise modifying and/or updating related management and/or configuration parameters and/or data.

Various embodiments of the invention may comprise a method and system for host independent platform diagnostics. The management controller 310 may provide host-independent diagnostic management servicing in the platform 300. The diagnostic management servicing may be based on one or more management protocols, such as the Web Service Management (WS-Management) protocols. The management controller 310 may incorporate one or more diagnostics based management interfaces for use during diagnostics servicing, such as the CIM based diagnostics interfacing and processing module 312 and the diagnostic alerts and indications service module 314, to enable exchanging diagnostics related management messages with management entities. The management controller 310 may independently interact with management entities that may manage the platform 300, and/or resources therein. The host-independent diagnostic management services provided by the management controller 310 may be based on diagnostic data and/or alerts generated by the plurality of managed entities 320 and/or the system BIOS 330 in the platform 300. The diagnostic data and/or alerts may be communicated by the plurality of managed entities 320 and/or the system BIOS 330 periodically, dynamically, and/or upon request by the management controller 310. The management controller 310 may log and/or store, via the diagnostics logging module 318, diagnostic data and/or alerts corresponding to the plurality of managed entities 320 and/or the system BIOS 330. The management controller 310 may communicate with the plurality of managed entities 320 and/or the system BIOS 330 to request and/or receive the diagnostic data and/or alerts. In this regard, the management controller 310 may communicate with the plurality of managed entities 320 using Platform Level Data Model (PLDM) based messaging for example, via the management-side PLDM interfacing and processing module 316 and the resource-side PLDM interfacing and processing module 322.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for host independent platform diagnostics.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
performing by a management controller in a network device, diagnostic service for a plurality of resources within said network device, wherein said management controller provides said diagnostic service independent of operation of said network device.

2. The method according to claim 1, wherein said management controller is integrated into a network controller in said network device.

3. The method according to claim 1, comprising performing said diagnostic service based on one or more management protocols, wherein said one or more management protocols comprise Web Service Management (WS-Management) based protocols.

4. The method according to claim 1, comprising performing by said management controller, diagnostics based management interface, wherein said diagnostics based management interface is operable to transmit and/or receive diagnostics related management messaging.

5. The method according to claim 4, comprising implementing said diagnostics based management interface using Common Information Model (CIM) data models.

6. The method according to claim 1, comprising communicating diagnostics alert based indications by said management controller during said diagnostics service by said management controller.

7. The method according to claim 1, comprising logging by said management controller diagnostic data and/or alerts generated by and/or corresponding to one or more of said plurality of managed resources.

8. The method according to claim 7, comprising receiving said diagnostic data and/or alerts from said plurality of managed resources to said management controller.

9. The method according to claim 1, comprising supporting use of Platform Level Data Model (PLDM) based interactions in said management controller for communicating with at least some of said plurality of managed resources.

10. The method according to claim 1, comprising triggering by said management controller diagnostics testing in one or more of said plurality of managed resources.

11. A system comprising:
one or more circuits and/or processors for use in a management controller in a network device, wherein said management controller provides diagnostic service for a plurality of resources within said network device independent of operation of said network device.

12. The system according to claim 11, wherein said management controller is integrated into a network controller in said network device.

13. The system according to claim 11, wherein said management controller is operable to provide said diagnostic service based on one or more management protocols, wherein said one or more management protocols comprise Web Service Management (WS-Management) based protocols.

14. The system according to claim 11, wherein said management controller is operable to provide diagnostics based management interface, wherein said diagnostics based management interface is operable to transmit and/or receive diagnostics related management messaging.

15. The system according to claim 14, wherein said one or more circuits and/or processors are operable to implement said diagnostics based management interface using Common Information Model (CIM) data models.

16. The system according to claim 11, wherein said management controller is operable to communicate diagnostics alert based indications by said management controller during said diagnostics service by said management controller.

17. The system according to claim 11, wherein said one or more circuits and/or processors are operable to log in said management controller diagnostic data and/or alerts generated by and/or corresponding to one or more of said plurality of managed resources.

18. The system according to claim 17, wherein said one or more circuits and/or processors are operable to receive said diagnostic data and/or alerts from said plurality of managed resources to said management controller.

19. The system according to claim 11, wherein said one or more circuits and/or processors are operable to support use of Platform Level Data Model (PLDM) based interactions in said management controller for communicating with at least some of said plurality of managed resources.

20. The system according to claim 11, wherein said management controller is operable to trigger diagnostics testing in one or more of said plurality of managed resources.
